(19) United States
(12) Patent Application Publication
(10) Pub. No.: US 2001/0032143 A1
(43) Pub. Date: Oct. 18, 2001

(54) Method and system providing out-sourced, merchandise return services

(75) Inventor: Arthur S. Haseltine, Springfield, MO (US)

Correspondence Address: Jonathan A. Bay, Attorney at Law, 333 Park Central East, Suite 314, Springfield, MO, 65806, US

(73) Assignee: ENHANCE, INC.

(21) Appl. No.: 09/752,980

(22) Filed: Dec. 29, 2000

Related U.S. Application Data
(60) Provisional application No. 60/174,466, filed on Dec. 30, 1999.

(51) Int. Cl. G06F 17/60

(52) U.S. Cl. 705/26; 705/28

(57) ABSTRACT

An out-sourced merchandise return system provides a general store enterprise of the type having a plurality of distributed store locations with an out-source service to offer another plurality of remote merchandisers. The general store enterprise is associated with a processing system that is linked with communication devices of the store locations by a communications medium, and which processes requests for merchandise-return information on merchandise presented to the store locations. The general store enterprise is further associated with a serving device for serving responsive communications to the communication devices of the requesting store locations. These responsive communications include either a positive or negative return decision and, in cases of positive return decisions, further comprise return fulfillment instructions.

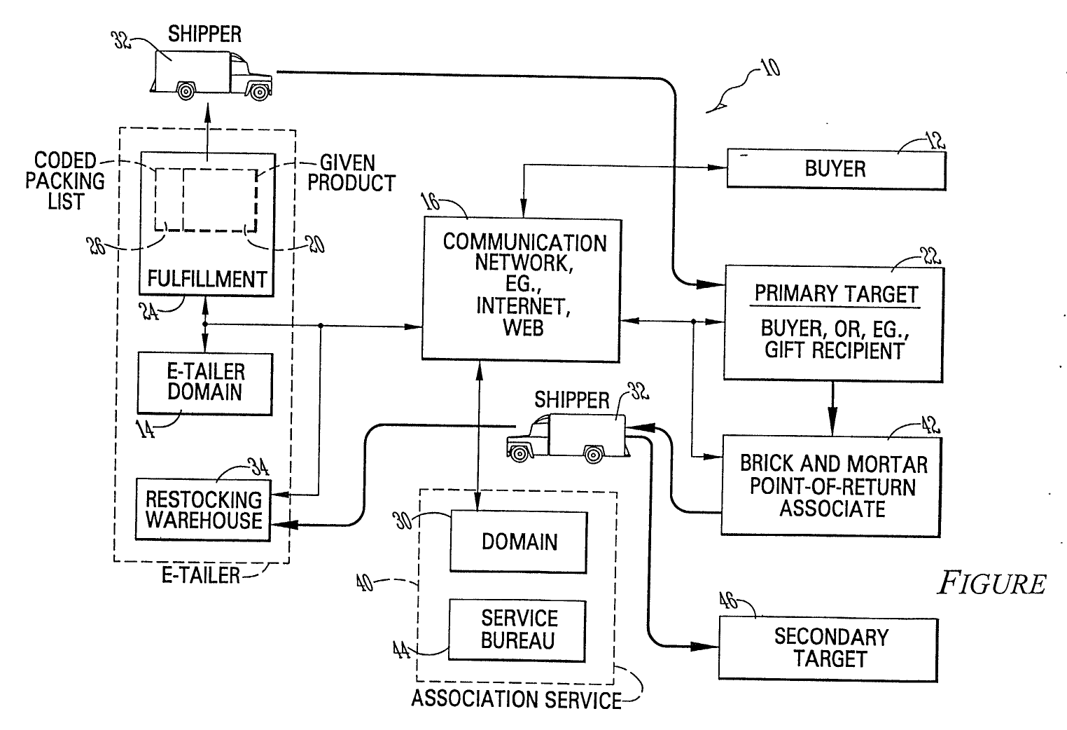

### CROSS-REFERENCE TO PROVISIONAL APPLICATION(S)

This application claims the benefit of U.S. Provisional Patent Application No. 60/174,466, filed Dec. 30, 1999.

This application is co-pending with commonly-invented, commonly-owned U.S. patent application Ser. No. 09/731,680, filed on Dec. 6, 2000.

### BACKGROUND AND SUMMARY OF THE INVENTION

The invention generally relates to distributed computer systems and/or networks of interconnected computer systems, and more particularly to a method and system providing out-sourced, merchandise return service(s) which in substantial measure is implemented over such distributed computer systems and/or networks of interconnected computer systems.

A number of additional features and objects will be apparent in connection with the following discussion of preferred embodiments and examples.

The method and system in accordance with the invention is broadly advantageous for establishing an out-sourced merchandise return service. For convenience of terminology in this description, the party or business concern receiving the out-sourcing business is termed the Service Bureau or at alternative other times, the Association Service. This service bureau predominantly is linked for communication by means of a computer-implemented server such as an Internet domain (for example, e-mail communication by an e-mail server) or even more preferably, a web domain (for example, web-page matter communication by a web domain). The party(ies) who are out-sourcing the merchandise return services may be referred to, needless to say, as merchandisers. More particularly, the profile of the representative merchandiser most likely to participate in this method of outsourcing return services, includes the following characteristics.

The representative merchandiser is likely a retail merchandiser. Such a representative merchandiser is also likely transacting all, perhaps a majority, or even just a significant portion of its business over the Internet. It offers its goods in major part across the Internet and not as much by catalog sales or by brick-and-mortar retail stores. Put differently, its “e-commerce” business is highly valued even if it also conducts catalog sales or sells through brick-and-mortar stores. Retail merchandiser's who transact the predominant share of their business over the Internet are sometimes known as “e-tailers.” A special class of e-tailers are the ones who essentially have no market presence other than their web store. Nowadays one of the largest and most recognized names among such e-tailers is AMAZON.COM®. But for every e-tailer the size of AMAZON.COM® or BARNESANDNOBLE.COM®, there are untold multitudes of others who are much more modest in size.

A problem facing all e-tailers, large and small, is the problem of merchandise returns. The following passage recites some aspects of the return problem for online merchandisers, particularly the specially focused e-tailers.

“Think about how often you receive unwanted presents. Sure, you appreciated the thought, but that hot-pink shirt from Aunt Thelma wouldn't have fit you even 15 pounds ago, and the color isn't remotely in your ‘palette.’ While returning the gift in the real world might mean waiting in long lines, the wait could be much more unpleasant online: You might not be able to return it at all.

“Consumers will spend at least $4.5 billion online this season, and of that, about 5 percent will be returned, estimates analyst Adam Sarner of the Gartner Group (IT) . . . .

“Web sites that don't allow consumers to return products to physical stores can certainly damage a brand's image, says Gartner's Sarner. A return can be “an opportunity for the store to sell another pair of pants, but they are basically turning customers away” by not accepting the returns in person, he says.

“Most Web sites have some form of return policy, but it might not be the most ideal for consumers, Sarner says. Some Web sites allow customers to return products, but charge a 50 percent restocking fee to cover shipping and handling costs. ‘We saw a lot of that a couple of years ago, but it has gotten a lot better,’ Sarner adds. Now a handful of merchants are covering all return shipping costs, and even allowing customers to return online purchases to their stores. But the majority of sites still have a lot of work to do on their return processes.

“The retail industry traditionally works on thin margins, and may be unprepared for the challenges posed by returns. Some retailers have gone for the simplified approach of creating Web versions of their catalogs. Other merchants have spun their Web sites into separate subsidiaries, using incompatible technologies to manage inventory. The results are Web sites that function with primitive back-office processing.

“To get returns under control, you can either out-source them to a shipper like FEDEX® or a fulfillment house like FINGERHUT®, or handle them in-house, as NORDSTROM® (NOBE) does. Whichever model you choose, you need good systems and real-time information to pull it off . . . .”

by Luisa Beltran, “Many Unhappy Returns” (Nov. 15, 1999), http://www.thestandard.com/article/display/0,1151,7458,00.html.

Framed in a different context, it is expected that the entry of WAL-MART® into e-commerce is going to adversely affect an e-tailer who competes on products head-to-head with WAL-MART®. To WAL-MART®'s advantage, it has a widely distributed infrastructure of brick-and-mortar stores. This facilitates more impulse buying than e-commerce. To WAL-MART®'s disadvantage, it has a widely distributed infrastructure of brick-and-mortar stores which are no doubt costly to maintain. To the e-tailer's advantage, it has virtually no brick-and-mortar overhead and thus can offer goods at perhaps lower prices because of the absence of such overhead. To the e-tailer's disadvantage, it has virtually no brick-and-mortar presence in a buyer's neighborhood. The absence of neighborliness aside, the e-tailer can't take back returns at the neighborhood outlet as say, WAL-MART® can.

What is needed is an improvement which addresses and overcomes the shortcomings of the prior art ways in which e-tailers can accomplish returns.

It is an object of the invention to establish a service for e-tailers in order to relieve such e-tailer's of the problem of returns, and do it highly cost effectively.

It is another object of the invention that the foregoing service operate in a manner likely to build goodwill with the purchasing public by virtue of a distributed network of point-of-return affiliates who will accept the e-tailer's returns on a walk-in basis in such associate's brick-and-mortar store. That is, the purchasing public ought to be pleased to carry out their returns of e-commerce purchases in stores in their own neighborhood.

It is an additional object of the invention that the above service and method of carrying out the returns include a compact token affixed to each product of each order fulfilled by an e-tailer, which token is encoded with packing-slip kinds of information. In a preferred embodiment, the token is preferably a point-of-fulfillment generated and affixed bar code.

It is an alternative object of the invention that the links of communication between the service, the e-tailers, and the point-of-return associates if not a wider public, be established on the Internet or the web for e-mail or web-page matter messaging and the like.

It is a further object of the invention that the above service provide various association services such as compilation of quality standards, menus of uniform return policies, train and certify point-of-return associates in the parameters governing obtaining authorization for return, and promoting the goodwill of the e-tailers who subscribe or associate with the service to their purchasing public.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims. In the drawings,

the sole FIGURE is a schematic diagram showing a method and system in accordance with the invention, for providing out-sourced, merchandise return services.

### DETAILED DESCRIPTION OF THE PREFERRED EMBODIMENTS

The sole FIGURE shows a method and system 10 in accordance with the invention, for providing out-sourced, merchandise return services. The FIGURE is highly simplified to show just the rudiments of a representative transaction in e-commerce, especially one where the recipient desires to return the received good(s). Aspects of this written description comprise an example to illustrate the diverse paths or routes taken by or available to not only the hardgoods but also the message information. However, the example is also simplified; persons having routine skill in the art recognize that the variety of transactions which the invention can service can take multiple diverse other forms. Accordingly, the example is relied on merely for convenience in this description and does not limit the invention to this one example only.

A buyer 12 has communicated to the e-tailer domain 14 online vis-a-vis the Internet or World Wide Web 16 or the like. Presumptively, the buyer and e-tailer are geographically remote from each other. Of the two, the buyer is least likely to know where the e-tailer may be physically found. Indeed, the e-tailer may be spread around. Regardless, the buyer orders a given product 20 or a set of products. Buyer also designates the order to be shipped to what is referred to in the drawing as the primary target 22. Payment is customarily achieved by credit card as VISA® or MASTERCARD® or the like. The primary target can be the buyer itself, or else a recipient other than the buyer, for example a gift recipient. In the majority of such e-commerce transactions, the e-tailer and primary target are likely to be geographically remote from each other.

The e-tailer prepares (or has prepared) the order for shipment by what is called a fulfillment process 24. Some e-tailers do order fulfilment in-house, others also outsource order fulfillment responsibilities. During the fulfillment process, an inventive packing slip 26 is developed and applied to the given product. Preferably, the inventive packing slip comprises a point-of-fulfilment generated bar code. It might alternatively be an encoded magnetic strip. Such a bar-coded packing slip is affixed by any suitable means to as much of the product that comprises a discrete, returnable unit. For example, if the returnable unit comprises a box of cookies, then it is the box and not the cookies which are affixed with the bar code. If on the other hand it is a carton of boxes, then it is the carton and not the individual boxes which are affixed with the bar code.

More significantly, if the discrete returnable unit is a garment, then preferably it is the garment to which the bar code is directly affixed. It is known by dry cleaning establishments to bar-code incoming laundry at point of intake. A paper sticker might suffice on some products, but something more durable might be needed on others. As mentioned with laundry, dry-cleaning establishments use an indelible dye applied directly to the garment or else to an iron-on patch applied to the garment. The goal is to affix the code or bar code as tightly (eg., semi-permanently) to the product or its packaging as need be in order to deter persons from frustrating the method by switching tags. The inventive bar-coded packing slip is to be distinguished from the very familiar, bar-coded UPC code. The UPC code only gives information regarding the given product.

In accordance with the invention, the bar-coded packing slip shall yield much more specific information surrounding the transaction as a whole, including some of the following items. The accessible information might include any or all of the following, if not more:—e.g., the identification of the e-tailer, the fulfillment service-provider, the shipper, the buyer, and the primary target; identification of the given product, which might be gotten by swiping (e.g., reading) the UPC code thereon; a statement of the return policy of that e-tailer and more particularly with respect to that class of products; and so on. This might be achieved by encoding the foregoing information into a bar code having sufficient bandwidth to record the message.

Alternatively, the bar code might merely be an address to a record stored on some computer-implemented storage device somewhere. One object of the invention is to configure the association's server domain 30 to process requests to decipher such inventive bar-coded packing slips. For example, let's say that the fulfillment service provider wants to read the bar code to see if it printed properly. The fulfillment service provider could read the bar code by a reading device inter-connected to the device on which the record is stored. Alternatively, the fulfillment service provider could read the bar code, and then transmit the bar code either over an e-mail server or web server, as appropriate, the URL address encoded in the bar code would serve as a request to the association's server to respond with the packing list data for reading or browsing by the fulfillment service provider. In its turn, the association's server 30 may act as a router and pull the record off the e-tailer's site 14. Alternatively, the association's server might have the record stored with devices within its own domain.

By any of the foregoing scenarios, including routine variations thereon, the following is achieved. The fulfillment service provider 24 (e.g., the requester) uses a swiping device to swipe the bar-coded packing list 26. The actual message read off the bar-coded packing list incorporates an address on the net or web, the submission of the actual message functioning like a request to view the packing list record, wherever that request may have to be routed. The destination of the request either directly or indirectly through requests of its own, sends or gets sent the packing list record to the requester. In this fashion, a relatively compact bar code can signify a voluminous mass of information which will greatly facilitate the return process, as more particularly described below.

To date, the given product has yet to clear the fulfillment service provider. The fulfillment service provider (which needless to say, may be the e-tailer itself) ships the order. Shipping is almost universally out-sourced to one of a few major nationwide if not international concerns. Progress continues, and the shipper 32 delivers the order to the primary target. Experience suggests that about ninety percent of the time (or so), the primary target keeps the order and attempts no return. The remaining other times, of course, the concern of the e-tailer is facilitating an authorized return to maintain goodwill but minimize if not eliminate the cost of such returns.

So, let's assume that the primary target wants to return the order, or at least a part thereof. For sake of convenience of an example, let's make the given product be what the primary target wants to return.

The primary target is one locale, but the e-tailer as well as the warehouse 34 the e-tailer will re-stock the return are located far away. Maybe the spread is a whole continent. It likely doesn't matter. The e-tailer is not likely to provide a walk-in service at its re-stocking warehouse 34.

Nevertheless, the primary target is informed by means of any various avenues of media, that the e-tailer participates in an association 40 such that the e-tailer has a distributed network of point-of-return affiliates 42 who will accept the return on a walk-in basis. Such affiliates 42 might be the private mailing enterprises that dot the country, including without limitation, PACK ‘N’ MAIL®, or MAIL BOXES ETC®, and so on. Although, it might turn out that the point-of-return affiliates work best if they come from a completely different industry than the private mailing enterprises. Indeed, it is believed that there will likely be competition by various brick-and-mortar stores to participate as such an affiliate for point-of-return association services. By doing so the brick-and-mortar stores gain for themselves increased customer traffic maybe not gotten by other means.

The point-of-return associate 42 provides walk-in processing of the primary target's request for return. The point-of-return associate reads or otherwise enters the immediate message given by the inventive bar-coded packing slip 26. Again, the immediate message might actually be a web request for the download of the more full record of the packing slip. However gotten, the point-of-return associate calls up the electronic packing slip. Unlike most paper packing slips seen nowadays, this inventive electronic packing slip includes precise information if not instructions to the point-of-return associate. Such information or instructions will guide this point-of-return associate on how to properly authorize the return of the given product of this e-tailer. The e-tailer might draft the criteria itself.

Assuming that the given item is passed for return, the instructions are further likely to tell the point-of-return associate (i) what to award to the individual bringing in the return, and (ii) what to do with the returned given item.

There are many options on what to award the individual bringing in the return. The options include (i) instant credit to the individual (regardless whether the actual buyer or not), (ii) credit to the buyer if different from the individual bringing in the return, or (iii) provisional credit, on the provision that the e-tailer certifies the propriety of the return once the e-tailer gets the given item back. The foregoing credits assume credit applicable with that e-tailer. Alternatively, another option might include (iv) credit with a broader community of merchants, perhaps every merchant and/or e-tailer who associates with or subscribes to the association's services. More basically, an alternative option could include (v) a direct refund, in cash or equivalent.

The next tack of the point-of-return associate is to route the returned item according to the instructions given by the packing slip. These instructions might come directly from the e-tailer. Alternatively, the instructions might have been composed by the service bureau 44. The instructions might be unchanged from the moment the bar-coded packing slip was created during the fulfillment process. More preferably, since the instructions are likely to be downloaded over the Internet or web, then this affords the e-tailer, the service bureau, or both in cooperation with each other, to dynamically update the downloadable instruction set depending on changed circumstances.

For example, the instructions might be relatively unchanging:—e.g., “Ship back via such-and-such shipper to re-stocking warehouse, always.” On the other hand, the downloadable instruction set might be perpetually in flux. One morning a given point-of-return associate might ship away a given item of a given retailer back to that e-tailer's customary re-stocking warehouse 34. That afternoon, the same point-of-return associate 42 might be instructed to ship away to the same given item of the very same given e-tailer, to a completely different destination.

This will be illustrated with an example. Let's say one child got for the holidays three (3) identical copies of the latest and most faddiest POKEMON® game toy, each one purchased from one e-tailer or another. Assume also that the givers of the gifts for this child acted early, and got these copies before the supply was exhausted for much of the rest of the public. Given the foregoing, our example child has brought in the two spare copies of the POKEMON® game toy to the neighborhood point-of-return associate, in Racine, Wis. The downloaded instructions say—rather than send back to the e-tailer's re-stocking warehouse in Los Angeles, do the following:—if the condition of the returned POKEMON® game toy meets given criteria, then (i) re-affix to the returned POKEMON® game toy a new bar-coded packing list as provided to, e.g., the point-of-return associate's web browser, and (ii) forward ship this POKEMON® game toy to another child in say, Madison, Wis.

In the FIGURE, this other child in (e.g.) Madison, Wis., is designated the secondary target 46.

The point of the foregoing example is the following. In cases of some returned items, it might be possible to have the point-of-return associate re-distribute the item to a more nearby secondary target, then ship it back to a far away re-stocking warehouse. The re-stocking warehouse might simply forward ship it to the secondary target anyway. But by the method in accordance with the invention, the action taken by the point-of-return associate to ship directly to the secondary target (when the condition of the returned item is sufficiently excellent to permit this) provides a twofold savings for the e-tailer. One, it saved the e-tailer the costs of two cross-country shipments for the price of one local shipping. And two, it got the secondary target its hoped for product much sooner. No doubt, some ideas stay in fashion regardless of the Internet, and speedy delivery is always fashionable and pleasing to the public.

With reference to the FIGURE, the service bureau 44 best services its populous community of e-tailers (e.g., 14) and brick-of-mortar point-of-return associates 42 with a variety of association services. For instance, the service bureau might compile a set of quality standards on about every aspect of the operation. The quality standards might insist that the point-of-return associates provide a clean and accessible store. The customer handling is speedy and affable. The point-of-return associates might be educated in diplomatic ways of handling irate customers, and not further fueling the angst. In respect of the e-tailers, they too must meet standards so that one or a few might not drag down the reputation of the community as a whole. Hence, the e-tailers are likely to be persuaded to the wisdom of a relatively relaxed return policy. If the criteria by which returns will be accepted is too stringent, then perhaps every customer attempting a return is going to be disappointed. To inform the public that there is an association and apparatus set up to facilitate returns, when in fact returns are seldom granted, is only likely to damage goodwill than build goodwill if not just prevent its loss. Therefore, the return policies of the various e-tailers have to be in fact real.

Indeed, another role for the service bureau 44 is to draft a short list of uniform return policies. The draft return policies are available for adoption by the e-tailers. Indeed the e-tailers likely would be induced to adopt a return policy from the association's menu. The purpose behind keeping the variety of return policies down to a few makes sense with the point-of-return associates. They ought to be so familiar with each one of the return policies on the menu that they can instantly act on any policy before a customer and apply the return policy accurately. The purpose behind keeping the different available return policies uniform serves a lot of the same reasons. The point-of-return associates ought not have to read and study a closely written legal document in order to facilitate a simple return. It will bog down the return service, and be un-popular with both customers and point-of-return associates. Of course, one of the association's persistent tasks is finding balance between what effectively serves the e-tailer community against what effectively serves the point-of-return associate community.

An additional role of the association 40 and/or 42 is to provide training if not certification for point-of-return associates. The point-of-return associates will likely have to add some hardware to their enterprise. Among the things they will need to have and need to know how to use include, a portal to the Internet, a bar-code reading device (or like device for reading the electronic packing list), and packing and shipping accessories. The training will also include customer relations as well as training in the technical matters of the return policies, what the return policies call for, and how to ensure that the respective e-tailer will honor the obligation to which the point-of-return associate is committing it.

A further role of the association 40 includes promoting the goodwill of the e-tailers who subscribe or associate with the service to their purchasing public. This likely includes advertising for the network of point-of-return associates. Further association services might include construction of regional re-stocking warehouses available only for the goods of e-tailers participating in the association. Also, the association might set up a financial services sub-service to facilitate multiple aspects of the operation. For example, any credit given to anybody might be honored by any member e-tailer of the association. Also, the financial services sub-service might pay the shippers on behalf of the submissions of the point-of-return associates, and then bill the applicable e-tailers afterwards.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. An out-sourced merchandise-return system providing a general store enterprise of the type having distributed store locations with a service to attract the public into any of the store locations who while visiting a given location to utilize the service might also utilize the visit to shop for and purchase unrelated goods at the given store location, the system comprising:
a plurality of remote merchandisers;
a distributed purchasing public of any of the remote merchandisers' merchandise;
a general store enterprise having distributed store locations at which the general store enterprise offers an out-sourced merchandise return service on behalf of the remote merchandisers as well as offers related packing, shipping and/or mailing supplies which are related by virtue of relating to effecting a merchandise return;
wherein said general store enterprise implements said out-sourced merchandise return service in part by provision of merchandise-return information storage means for storing merchandise-return information applicable to merchandise of the merchandisers; and
wherein the distributed store locations are linked to the merchandise-return information storage means by a communications medium and handle physical processing of returns of purchased merchandise submitted to a given store location if clearance is obtained after contacting the merchandise-return information storage means;
whereby said out-sourced merchandise-return system affords the general store enterprise opportunities to attract the distributed purchasing public of the remote merchandisers into its store locations so such public while visiting a given location to utilize the service might also utilize the visit to shop for and purchase unrelated goods at the given store location.

2. The merchandise return system of claim 1 wherein:
the merchandise-return information stored on the storage means includes information on original sales transactions by which a given merchandiser fulfilled or caused fulfillment of orders of merchandise.

3. The merchandise return system of claim 2 further comprising:
merchandise identifiers attached to returnable units of merchandise during or before order fulfillment wherein the identifiers facilitate research of information in the merchandise-return information storage means.

4. The merchandise return system of claim 1 wherein the plurality of remote merchandisers deal in a wide variety of differing goods and the general store enterprise offers goods arguably competitive with the goods of the merchandisers.

5. The merchandise return system of claim 4 wherein the general store enterprise comprises one of WAL-MART® or another like major store enterprise.

6. The merchandise return system of claim 1 wherein the merchandise-return information storage means in part includes access to portions of at least one storage means controlled by at least one of the plurality of remote merchants.

7. The merchandise return system of claim 1 wherein the merchandise-return information storage means includes pertinent return-authorization criteria; and
further comprising processing means, activated by contact from any of the given store locations combined with at least an identifying designation of the merchandise presented for return to the given store location, for serving a return-clearance message.

8. The merchandise return system of claim 7 wherein the return-authorization message further comprises return fulfillment instructions in cases of positive return-clearance messages.

9. The merchandise return system of claim 1 further comprising a processing system associated with the merchandise-return information storage means, for processing contacts by the given store locations requesting merchandise-return information on merchandise presented thereto; and
means for serving responsive communications to the pertinent requesting store location.

10. The merchandise return system of claim 9 wherein the responsive communications include either a positive or negative return decision and, in cases of positive return decisions, further comprise return fulfillment instructions.

11. The merchandise return system of claim 9 wherein the responsive communications include either a positive or negative return decision and, in cases of positive return decisions, further comprise an award instruction applicable to the party presenting the return merchandise or else another party, which award instruction can be chosen from any of instant credit, credit provisional that the merchandiser certifies the propriety of the return upon a later date or event, credit honored by a given association of merchants only, a direct refund in cash or equivalent, and/or any combinations thereof.

12. The merchandise return system of claim 9 further comprising:
merchandise identifiers attached to returnable units of merchandise during or before the original sales transaction therefor wherein the identifiers facilitate the processing system in forming a responsive communication.

13. The merchandise return system of claim 12 wherein the merchandise identifiers comprise bar codes which when scanned decode into a URL address and the request to be processed by the processing system.

14. The merchandise return system of claim 1 wherein the plurality of remote merchandisers comprise assorted online boutique.
